(19) United States
(12) Patent Application Publication
(10) Pub. No.: US 2024/0273137 A1
(43) Pub. Date: Aug. 15, 2024

(54) Systems and Methods for Searching Audio Content

(71) Applicant: Spotify AB, Stockholm (SE)

(72) Inventors: Xingran Zhu, New York, NY (US); Diego Fernando Lorenzo Casabuena Gonzalez, Brooklyn, NY (US); Ann Clifton, Lopez Island, WA (US); Daren Keith Gill, New York, NY (US)

(21) Appl. No.: 18/169,093

(22) Filed: Feb. 14, 2023

(51) Int. Cl. G06F 16/635; G06F 16/638

(52) U.S. Cl. CPC G06F 16/635; G06F 16/638

(57) ABSTRACT

The various implementations described herein include methods and devices for searching of audio content. In one aspect, a method includes obtaining a query string for audio content and obtaining a plurality of audio content results corresponding to the query string. The method further includes selecting a subset of results from the plurality of audio content results, including selecting respective search results from a plurality of sub-topic clusters, and sequencing the subset of audio content results. The method also includes causing the sequenced subset of audio content results to be presented to a user.

### RELATED APPLICATIONS

This application is related to U.S. patent application Ser. No. 18/063,023, entitled “Systems and Methods for Facilitating Semantic Search of Audio Content,” filed Dec. 7, 2022, which is hereby incorporated by reference in its entirety.

### TECHNICAL FIELD

The disclosed embodiments relate generally to searching audio content including, but not limited to, systems and methods for selecting and sequencing subsets of audio content results.

### BACKGROUND

Recent years have shown a remarkable growth in consumption of digital goods such as digital music, movies, books, and podcasts, among many others. The overwhelmingly large number of these goods often makes navigation and discovery of new digital goods an extremely difficult task. In particular, each of these digital goods can be quite long and cover multiple topics, songs, and/or chapters.

Recommender systems commonly retrieve preferred items for users from a massive number of items by modeling users' interests based on historical interactions. However, reliance on lexical search and/or historical interaction data is limiting for user exploration and item discovery. This problem is further aggravated for long media items and media items with limited metadata and/or labels.

### SUMMARY

Search systems and knowledge graphs are examples of tools that are generally able to collate sets of related content, e.g., by gathering similar items to an input query. However, these tools do not use segmentation to surface shorter, locally interesting segments of content, and do not enforce diversity in the set of content items gathered in relation to the query. Enforcing diversity provides a diverse experience for the user (e.g., by applying result diversification via deduplication and hygiene rules). Additionally, some tools generate playlists of content, but are manually (editorially) created, rather than automatically (e.g., algorithmically computed) generated.

These conventional systems and tools do not provide fine-grained, segmented sets of related content. The conventional systems and tools also do not enforce diversity in the result. Moreover, the manually-curated systems do not scale to large amounts of data.

The present disclosure describes obtaining a selection of results from a pool of segmented content, e.g., enforcing both relevance and diversity within the selected results. For example, the disclosed systems may make a global selection that optimizes for total relevance and diversity within the final set, rather than greedily selecting the top-k most relevant items. Optimizing for diversity may include applying result diversification as well as semantic selection and sequencing techniques on the globally-selected set to improve diversity within the final set. The present disclosure also describes assembling a set of selected segment content and providing context to a listener in interpreting the content by providing summaries and metadata (e.g., titles, themes, and/or factlets) to be read aloud by a text-to-speech (TTS) system for an end-to-end audio listening experience.

In accordance with some embodiments, a method of searching audio content is provided. The method includes: (i) obtaining a query string for audio content; (ii) obtaining a plurality of audio content results corresponding to the query string; (iii) selecting a subset of results from the plurality of audio content results, including selecting respective search results from a plurality of sub-topic clusters; (iv) sequencing the subset of audio content results; and (v) causing the sequenced subset of audio content results to be presented to a user.

In accordance with some embodiments, an electronic device is provided. The electronic device includes one or more processors and memory storing one or more programs. The one or more programs include instructions for performing any of the methods described herein (e.g., the method 600).

In accordance with some embodiments, a non-transitory computer-readable storage medium is provided. The non-transitory computer-readable storage medium stores one or more programs for execution by an electronic device with one or more processors. The one or more programs comprising instructions for performing any of the methods described herein (e.g., the method 600).

Thus, devices and systems are disclosed with methods for searching audio content and providing results to users. Such methods, devices, and systems may complement or replace conventional methods, devices, and systems for searching audio content and providing results.

### BRIEF DESCRIPTION OF THE DRAWINGS

The embodiments disclosed herein are illustrated by way of example, and not by way of limitation, in the figures of the accompanying drawings. Like reference numerals refer to corresponding parts throughout the drawings and specification.

FIG. 1 is a block diagram illustrating an example media content delivery system in accordance with some embodiments.

FIG. 2 is a block diagram illustrating an example electronic device in accordance with some embodiments.

FIG. 3 is a block diagram illustrating an example media content server in accordance with some embodiments.

FIG. 4 is a block diagram illustrating an example process for sequencing content in accordance with some embodiments.

FIG. 5 illustrates an example topic space with sub-topic clusters in accordance with some embodiments.

FIG. 6 is a flow diagram illustrating a method of recommending content to a user in accordance with some embodiments.

### DETAILED DESCRIPTION

Reference will now be made to embodiments, examples of which are illustrated in the accompanying drawings. In the following description, numerous specific details are set forth in order to provide an understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

Podcasts and other audio content can have long duration (e.g., multiple hours), and the number of audio content items (e.g., shows) is quickly increasing. Listeners who want a well-rounded perspective on a topic, but don't have time to listen to all the relevant episodes in full may prefer a set of audio content segments as sub-regions from the episodes that are specifically related to the designated topic (e.g., represent the episodes in the context of the designated topic). Accordingly, the present disclosure describes automated processes for generating thematic playlists of audio content segments (e.g., podcast chapters).

For example, the systems described herein can obtain inferred segments from a segmentation model (e.g., to acquire relevant chapter-style clips (e.g., topic-wise self-contained clips) from different episodes). The obtained segments can be presented in a sequenced set to create a unified experience. This is similar to how listeners can select songs from different albums and put them together into a playlist, e.g., that captures a particular feeling or activity. The sequenced sets of segments can allow listeners to enjoy highlights that capture a particular topic in a much shorter amount of time than it would take to sift through and listen to many hours of individual content items relevant to the topic in order to identify the relevant regions themselves.

The present disclosure describes selecting segments from a pool of content to create a sequenced set that is relevant to a given topic and also enforces diversity within the selected segments, e.g., to ensure that the content chosen within the set is non-repetitive and provides diverse perspectives on the given topic. Further, the systems described herein may use a summary generation model to explain and/or contextualize the content segments in the sequenced set (e.g., generate titles, theme summaries, and/or factlets).

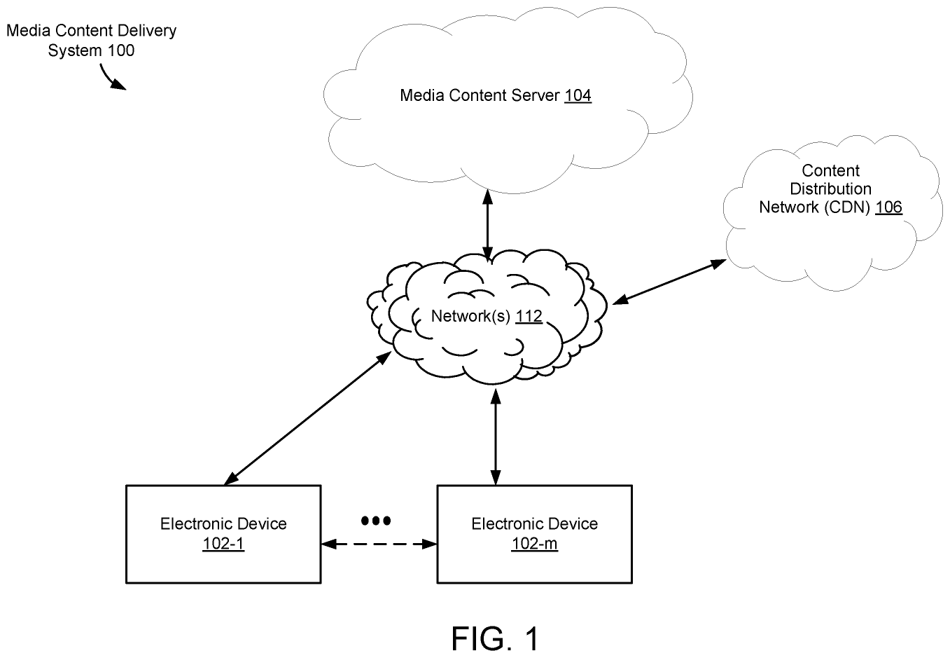

Turning now to the figures, FIG. 1 is a block diagram illustrating a media content delivery system 100 in accordance with some embodiments. The media content delivery system 100 includes one or more electronic devices 102 (e.g., electronic device 102-1 to electronic device 102-m, where m is an integer greater than one), one or more media content servers 104, and/or one or more content distribution networks (CDNs) 106. The one or more media content servers 104 are associated with (e.g., at least partially compose) a media-providing service. The one or more CDNs 106 store and/or provide one or more content items (e.g., to electronic devices 102). In some embodiments, the CDNs 106 are included in the media content servers 104. One or more networks 112 communicably couple the components of the media content delivery system 100. In some embodiments, the one or more networks 112 include public communication networks, private communication networks, or a combination of both public and private communication networks. For example, the one or more networks 112 can be any network (or combination of networks) such as the Internet, other wide area networks (WAN), local area networks (LAN), virtual private networks (VPN), metropolitan area networks (MAN), peer-to-peer networks, and/or ad-hoc connections.

In some embodiments, an electronic device 102 is associated with one or more users. In some embodiments, an electronic device 102 is a personal computer, mobile electronic device, wearable computing device, laptop computer, tablet computer, mobile phone, feature phone, smart phone, an infotainment system, digital media player, a speaker, television (TV), and/or any other electronic device capable of presenting media content (e.g., controlling playback of media items, such as music tracks, podcasts, videos, etc.). Electronic devices 102 may connect to each other wirelessly and/or through a wired connection (e.g., directly through an interface, such as an HDMI interface). In some embodiments, electronic devices 102-1 and 102-m are the same type of device (e.g., electronic device 102-1 and electronic device 102-m are both speakers). Alternatively, electronic device 102-1 and electronic device 102-m include two or more different types of devices.

In some embodiments, electronic devices 102-1 and 102-m send and receive media-control information through network(s) 112. For example, electronic devices 102-1 and 102-m send media control requests (e.g., requests to play music, podcasts, movies, videos, or other media items, or playlists thereof) to media content server 104 through network(s) 112. Additionally, electronic devices 102-1 and 102-m, in some embodiments, also send indications of media content items to media content server 104 through network(s) 112. In some embodiments, the media content items are uploaded to electronic devices 102-1 and 102-m before the electronic devices forward the media content items to media content server 104.

In some embodiments, electronic device 102-1 communicates directly with electronic device 102-m (e.g., as illustrated by the dotted-line arrow), or any other electronic device 102. As illustrated in FIG. 1, electronic device 102-1 is able to communicate directly (e.g., through a wired connection and/or through a short-range wireless signal, such as those associated with personal-area-network (e.g., BLUETOOTH/BLE) communication technologies, radio-frequency-based near-field communication technologies, infrared communication technologies, etc.) with electronic device 102-m. In some embodiments, electronic device 102-1 communicates with electronic device 102-m through network(s) 112. In some embodiments, electronic device 102-1 uses the direct connection with electronic device 102-m to stream content (e.g., data for media items) for playback on the electronic device 102-m.

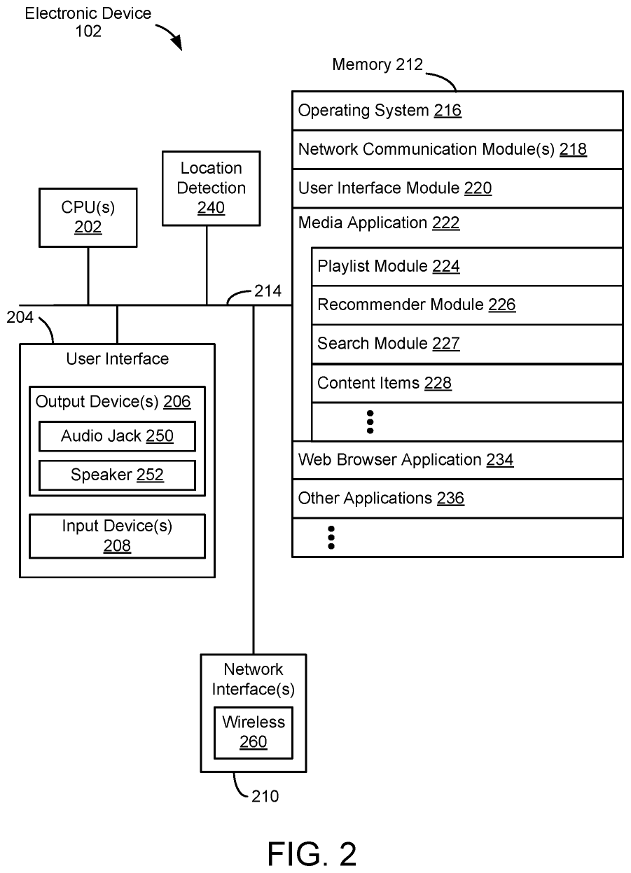

In some embodiments, electronic device 102-1 and/or electronic device 102-m include a media application 222 (FIG. 2) that allows a respective user of the respective electronic device to upload (e.g., to media content server 104), browse, request (e.g., for playback at the electronic device 102), and/or present media content (e.g., control playback of music tracks, playlists, videos, etc.). In some embodiments, one or more media content items are stored locally by an electronic device 102 (e.g., in memory 212 of the electronic device 102, FIG. 2). In some embodiments, one or more media content items are received by an electronic device 102 in a data stream (e.g., from the CDN 106 and/or from the media content server 104). The electronic device(s) 102 are capable of receiving media content (e.g., from the CDN 106) and presenting the received media content. For example, electronic device 102-1 may be a component of a network-connected audio/video system (e.g., a home entertainment system, a radio/alarm clock with a digital display, or an infotainment system of a vehicle). In some embodiments, the CDN 106 sends media content to the electronic device(s) 102.

In some embodiments, the CDN 106 stores and provides media content (e.g., media content requested by the media application 222 of electronic device 102) to electronic device 102 via the network(s) 112. Content (also referred to herein as “media items,” “media content items,” and “content items”) is received, stored, and/or served by the CDN 106. In some embodiments, content includes audio (e.g., music, spoken word, podcasts, audiobooks, etc.), video (e.g., short-form videos, music videos, television shows, movies, clips, previews, etc.), text (e.g., articles, blog posts, emails, etc.), image data (e.g., image files, photographs, drawings, renderings, etc.), games (e.g., 2- or 3-dimensional graphics-based computer games, etc.), or any combination of content types (e.g., web pages that include any combination of the foregoing types of content or other content not explicitly listed). In some embodiments, content includes one or more audio media items (also referred to herein as “audio items,” “tracks,” and/or “audio tracks”).

In some embodiments, media content server 104 receives media requests (e.g., commands) from electronic devices 102. In some embodiments, media content server 104 includes a voice API, a connect API, and/or key service. In some embodiments, media content server 104 validates (e.g., using key service) electronic devices 102 by exchanging one or more keys (e.g., tokens) with electronic device(s) 102.

In some embodiments, media content server 104 and/or CDN 106 stores one or more playlists (e.g., information indicating a set of media content items). For example, a playlist is a set of media content items defined by a user and/or defined by an editor associated with a media-providing service. The description of the media content server 104 as a “server” is intended as a functional description of the devices, systems, processor cores, and/or other components that provide the functionality attributed to the media content server 104. It will be understood that the media content server 104 may be a single server computer, or may be multiple server computers. Moreover, the media content server 104 may be coupled to CDN 106 and/or other servers and/or server systems, or other devices, such as other client devices, databases, content delivery networks (e.g., peer-to-peer networks), network caches, and the like. In some embodiments, the media content server 104 is implemented by multiple computing devices working together to perform the actions of a server system (e.g., cloud computing).

FIG. 2 is a block diagram illustrating an electronic device 102 (e.g., electronic device 102-1 and/or electronic device 102-m, FIG. 1), in accordance with some embodiments. The electronic device 102 includes one or more central processing units (CPU(s), e.g., processors or cores) 202, one or more network (or other communications) interfaces 210, memory 212, and one or more communication buses 214 for interconnecting these components. The communication buses 214 optionally include circuitry (sometimes called a chipset) that interconnects and controls communications between system components.

In some embodiments, the electronic device 102 includes a user interface 204, including output device(s) 206 and/or input device(s) 208. In some embodiments, the input devices 208 include a keyboard, mouse, or track pad. Alternatively, or in addition, in some embodiments, the user interface 204 includes a display device that includes a touch-sensitive surface, in which case the display device is a touch-sensitive display. In electronic devices that have a touch-sensitive display, a physical keyboard is optional (e.g., a soft keyboard may be displayed when keyboard entry is needed). In some embodiments, the output devices (e.g., output device(s) 206) include a speaker 252 (e.g., speakerphone device) and/or an audio jack 250 (or other physical output connection port) for connecting to speakers, earphones, headphones, or other external listening devices. Furthermore, some electronic devices 102 use a microphone and voice recognition device to supplement or replace the keyboard. Optionally, the electronic device 102 includes an audio input device (e.g., a microphone) to capture audio (e.g., speech from a user).

Optionally, the electronic device 102 includes a location-detection device 240, such as a global navigation satellite system (GNSS) (e.g., GPS (global positioning system), GLONASS, Galileo, BeiDou) or other geo-location receiver, and/or location-detection software for determining the location of the electronic device 102 (e.g., module for finding a position of the electronic device 102 using trilateration of measured signal strengths for nearby devices).

In some embodiments, the one or more network interfaces 210 include wireless and/or wired interfaces for receiving data from and/or transmitting data to other electronic devices 102, a media content server 104, a CDN 106, and/or other devices or systems. In some embodiments, data communications are carried out using any of a variety of custom or standard wireless protocols (e.g., NFC, RFID, IEEE 802.15.4, Wi-Fi, ZigBee, 6LoWPAN, Thread, Z-Wave, Bluetooth, ISA100.11a, WirelessHART, MiWi, etc.). Furthermore, in some embodiments, data communications are carried out using any of a variety of custom or standard wired protocols (e.g., USB, Firewire, Ethernet, etc.). For example, the one or more network interfaces 210 include a wireless interface 260 for enabling wireless data communications with other electronic devices 102, media presentations systems, and/or or other wireless (e.g., Bluetooth-compatible) devices (e.g., for streaming audio data to the media presentations system of an automobile). Furthermore, in some embodiments, the wireless interface 260 (or a different communications interface of the one or more network interfaces 210) enables data communications with other WLAN-compatible devices (e.g., a media presentations system) and/or the media content server 104 (via the one or more network(s) 112, FIG. 1).

In some embodiments, electronic device 102 includes one or more sensors including, but not limited to, accelerometers, gyroscopes, compasses, magnetometer, light sensors, near field communication transceivers, barometers, humidity sensors, temperature sensors, proximity sensors, range finders, and/or other sensors/devices for sensing and measuring various environmental conditions.

Memory 212 includes high-speed random-access memory, such as DRAM, SRAM, DDR RAM, or other random-access solid-state memory devices; and may include non-volatile memory, such as one or more magnetic disk storage devices, optical disk storage devices, flash memory devices, or other non-volatile solid-state storage devices. Memory 212 may optionally include one or more storage devices remotely located from the CPU(s) 202. Memory 212, or alternately, the non-volatile memory solid-state storage devices within memory 212, includes a non-transitory computer-readable storage medium. In some embodiments, memory 212 or the non-transitory computer-readable storage medium of memory 212 stores the following programs, modules, and data structures, or a subset or superset thereof:
an operating system 216 that includes procedures for handling various basic system services and for performing hardware-dependent tasks;
network communication module(s) 218 for connecting the electronic device 102 to other computing devices (e.g., media presentation system(s), media content server 104, and/or other client devices) via the one or more network interface(s) 210 (wired or wireless) connected to one or more network(s) 112;
a user interface module 220 that receives commands and/or inputs from a user via the user interface 204 (e.g., from the input devices 208) and provides outputs for playback and/or display on the user interface 204 (e.g., the output devices 206);
a media application 222 (e.g., an application for accessing a media-providing service of a media content provider associated with media content server 104) for uploading, browsing, receiving, processing, presenting, and/or requesting playback of media (e.g., media items). In some embodiments, media application 222 includes a media player, a streaming media application, and/or any other appropriate application or component of an application. In some embodiments, media application 222 is used to monitor, store, and/or transmit (e.g., to media content server 104) data associated with user behavior. In some embodiments, media application 222 also includes the following modules (or sets of instructions), or a subset or superset thereof:
   a playlist module 224 for storing sets of media items for playback in a predefined order;
   a recommender module 226 for identifying and/or displaying recommended media items to include in a playlist;
   a search module 227 for identifying and presenting media items to a user in response to one or more queries; and
   a content items module 228 for storing media items, including audio items such as podcasts and songs, for playback and/or for forwarding requests for media content items to the media content server;
a web browser application 234 for accessing, viewing, and interacting with web sites; and
other applications 236, such as applications for word processing, calendaring, mapping, weather, stocks, time keeping, virtual digital assistant, presenting, number crunching (spreadsheets), drawing, instant messaging, e-mail, telephony, video conferencing, photo management, video management, a digital music player, a digital video player, 2D gaming, 3D (e.g., virtual reality) gaming, electronic book reader, and/or workout support.

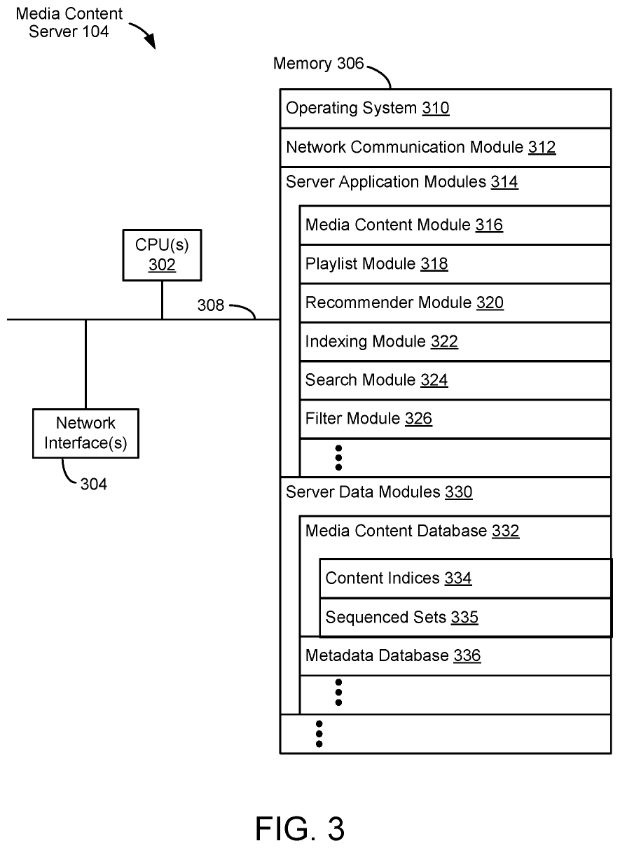

FIG. 3 is a block diagram illustrating a media content server 104, in accordance with some embodiments. The media content server 104 typically includes one or more central processing units/cores (CPUs) 302, one or more network interfaces 304, memory 306, and one or more communication buses 308 for interconnecting these components.

Memory 306 includes high-speed random-access memory, such as DRAM, SRAM, DDR RAM, or other random access solid-state memory devices; and may include non-volatile memory, such as one or more magnetic disk storage devices, optical disk storage devices, flash memory devices, or other non-volatile solid-state storage devices. Memory 306 optionally includes one or more storage devices remotely located from one or more CPUs 302. Memory 306, or, alternatively, the non-volatile solid-state memory device(s) within memory 306, includes a non-transitory computer-readable storage medium. In some embodiments, memory 306, or the non-transitory computer-readable storage medium of memory 306, stores the following programs, modules and data structures, or a subset or superset thereof:
an operating system 310 that includes procedures for handling various basic system services and for performing hardware-dependent tasks;
a network communication module 312 that is used for connecting the media content server 104 to other computing devices via one or more network interfaces 304 (wired or wireless) connected to one or more networks 112;
one or more server application modules 314 for performing various functions with respect to providing and managing a content service, the server application modules 314 including, but not limited to, one or more of:
   a media content module 316 for storing one or more media content items and/or sending (e.g., streaming), to the electronic device, one or more requested media content item(s);
   a playlist module 318 for storing and/or providing (e.g., streaming) sets of media content items to the electronic device. In some embodiments, the playlist module 318 sequences the media content items into a sequenced set (e.g., a playlist) based on chronology, sentiment, textual entailment, level of detail, specificity, and the like;
   a recommender module 320 for determining and/or providing recommendations for a playlist;
   an indexing module 322 for identifying topics within media items and generating topic indices for the media items;
   a search module 324 for searching one or more databases (e.g., the media content database 332 and/or the content indices 334) in response to user and/or system queries; and
   a filter module 326 for filtering results from the search module 324 and/or selecting subsets of results from the search module 324 (e.g., based on recency, duration, sub-topic diversity, audio events (e.g., speech versus non-speech audio), and the like); and
one or more server data module(s) 330 for handling the storage of and/or access to media items and/or metadata relating to the media items; in some embodiments, the one or more server data module(s) 330 include:
   a media content database 332 for storing media items. In some embodiments, the media content database 332 includes one or more content indices 334 (e.g., generated via the indexing module 322). In some embodiments, the media content database 332 includes one or more sequenced sets 335 (e.g., generated via the playlist module 318); and
   a metadata database 336 for storing metadata relating to the media items, such as a genre associated with the respective media items.

In some embodiments, the media content server 104 includes web or Hypertext Transfer Protocol (HTTP) servers, File Transfer Protocol (FTP) servers, as well as web pages and applications implemented using Common Gateway Interface (CGI) script, PHP Hyper-text Preprocessor (PHP), Active Server Pages (ASP), Hyper Text Markup Language (HTML), Extensible Markup Language (XML), Java, JavaScript, Asynchronous Javascript and XML (AJAX), XHP, Javelin, Wireless Universal Resource File (WURFL), and the like.

Each of the above identified modules stored in memory 212 and 306 corresponds to a set of instructions for performing a function described herein. The above identified modules or programs (e.g., sets of instructions) need not be implemented as separate software programs, procedures, or modules, and thus various subsets of these modules may be combined or otherwise re-arranged in various embodiments. In some embodiments, memory 212 and 306 optionally store a subset or superset of the respective modules and data structures identified above. Furthermore, memory 212 and 306 optionally store additional modules and data structures not described above.

Although FIG. 3 illustrates the media content server 104 in accordance with some embodiments, FIG. 3 is intended more as a functional description of the various features that may be present in one or more media content servers than as a structural schematic of the embodiments described herein. In practice, and as recognized by those of ordinary skill in the art, items shown separately could be combined and some items could be separated. For example, some items shown separately in FIG. 3 could be implemented on single servers and single items could be implemented by one or more servers. In some embodiments, media content database 332 and/or metadata database 336 are stored on devices (e.g., CDN 106) that are accessed by media content server 104. The actual number of servers used to implement the media content server 104, and how features are allocated among them, will vary from one implementation to another and, optionally, depends in part on the amount of data traffic that the server system handles during peak usage periods as well as during average usage periods.

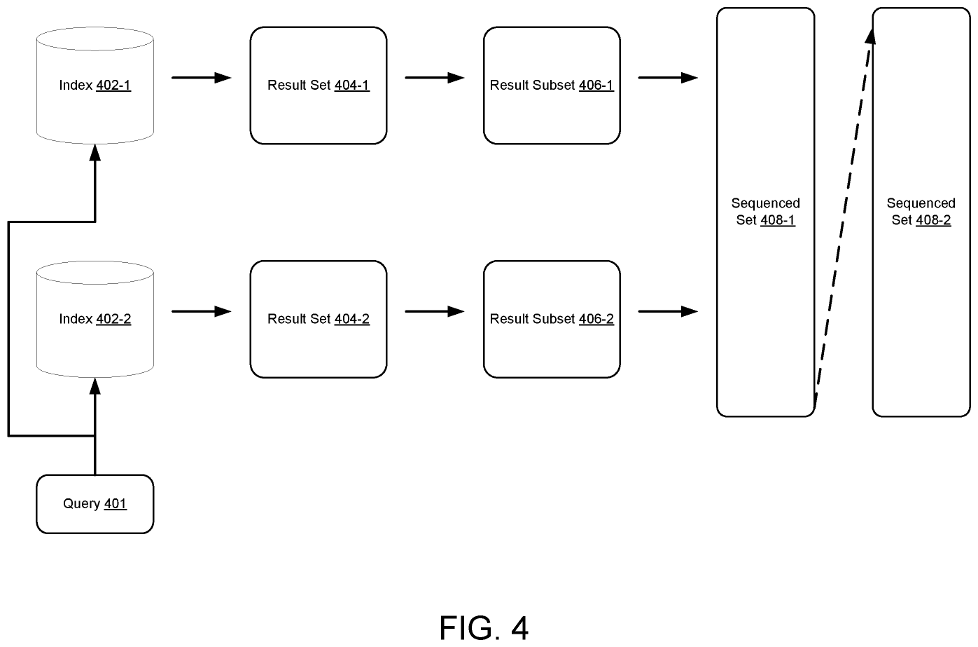

FIG. 4 is a block diagram illustrating an example process for sequencing content in accordance with some embodiments. As shown in FIG. 4, a query 401 is received and used to obtain result sets 404 from the indices 402. In some embodiments, the query 401 is a topic received from a listener (consumer) or an administrator. In the example of FIG. 4, the result sets 404-1 and 404-2 are obtained from indices 402-1 and 402-2 respectively. In some embodiments, two or more result sets 404 are obtained from a same index. In some embodiments, the indices 402 are topic indices (e.g., comprising topic embeddings of media items and/or segments). For example, a topic representation (e.g., embedding) of the query 401 is generated and matched to one or more topics of the topic indices. The topics may include one or more words and/or expressions. In some embodiments, each index 402 includes media item segments (e.g., podcast chapters and/or clips). In some embodiments, the media item segments are obtained from a content provider (e.g., a podcast creator) and/or generated by segmenting larger media items (e.g., segmenting a podcast, talk show, or audio book) algorithmically and/or manually.

Result subsets 406 are identified from the result sets 404. In the example of FIG. 4, a respective subset is identified from each result set. For example, the result subset 406-1 is identified from the result set 404-1 and the result subset 406-2 is identified from the result set 404-2. In some embodiments, the result sets 404 are combined before the result subset(s) are identified (e.g., to produce a single result subset). In some embodiments, the result subsets 406 are identified by filtering the result sets 404. In some embodiments, the filtering includes filtering based on recency (e.g., filtering out older content items), duration (e.g., filtering out content items that are too short or too long), audio events (e.g., filtering out non-speech audio regions) and/or user preferences (e.g., filtering out explicit content and/or content in a language not selected by a user). In some embodiments, the filtering includes filtering out duplicate content. In some embodiments, the filtering includes filtering the result set(s) 404 based on relevance scores and/or recency of publication. For example, the result set(s) 404 may include around 1,000 results and the result subset(s) 406 may include around 100 results (e.g., ensuring a high level of relevance to the query 401).

In some embodiments, identifying the result subsets 406 from the result sets 404 includes mapping the results in the result set(s) 404 to sub-topic clusters and selecting results from the sub-clusters for the result subset(s) 406. For example, selecting a result nearest to a centroid of each sub-topic cluster for the result subset(s) 406. In some embodiments, clustering is performed on the filtered results from the result set(s) 404 (e.g., to capture different aspects of the query and/or query topic). In some embodiments, the clustering is unsupervised clustering (e.g., using k-means). In some embodiments, a desired number of clusters for the clustering is preset. In some embodiments, a desired number of media items for each result subset 406 is preset. In some embodiments, the clustering is nonparametric clustering (e.g., the number of clusters is automatically discovered based on differences in the data pool). In some embodiments, the media items (e.g., audio content segments) are clustered based on a representation of the speech in each item (e.g., a bag-of-words vector representation, a latent Dirichlet allocation (LDA) representation, and/or a semantic embedding of the text). In some embodiments, one or more media items are selected from each cluster for each result subset 406. In some embodiments, a media item closest to a centroid of each cluster is selected. In some embodiments, a media item is selected using a weighted selection based on item features (e.g., popularity and/or user affinity).

The result subset(s) 406 are arranged into a sequenced set 408-1. In some embodiments, the sequencing includes ordering the media item results in the result subset(s) 406 based on level of detail/specificity (e.g., results with more general discussion before results with more detailed/nuanced discussions). In some embodiments, the sequencing includes ordering the media item results in the result subset(s) 406 based on chronology, sentiment, and/or textual entailment. In some embodiments, the sequencing methodology is selected based on the topic of the query 401. In some embodiments, a sequenced set 408-2 is identified for combining (appending) to the sequenced set 408-1. For example, after a user listens to the sequenced set 408-1 for the queried topic, the sequenced set 408-2 is presented for a related topic.

In some embodiments, the sequencing methodology is based on content type (e.g., audio content or audiovisual content). In some embodiments, the sequencing methodology is based on segment metadata (e.g., segment length/duration). In some embodiments, the sequencing methodology is based on the given topic (e.g., a current news topic uses a different sequencing methodology than a historical event topic). In some embodiments, the sequencing methodology is one of: random sequencing, entailment-based sequencing (e.g., computing entailment scores between items), alternating sentiment polarity sequencing (e.g., using sentiment analysis), and narrative structure sequencing (e.g., from general to more specific). In some embodiments, the narrative structure sequencing is based on cluster size (e.g., where a larger cluster is considered more general). In some embodiments, the narrative structure sequencing is based on respective term frequency inverse document frequency (TF-IDF) vectors for the clusters. For example, the TF-IDF vectors indicate how spread out the vocabulary is over a total vocabulary for all clusters versus how specific the vocabulary used in a particular cluster is to that cluster.

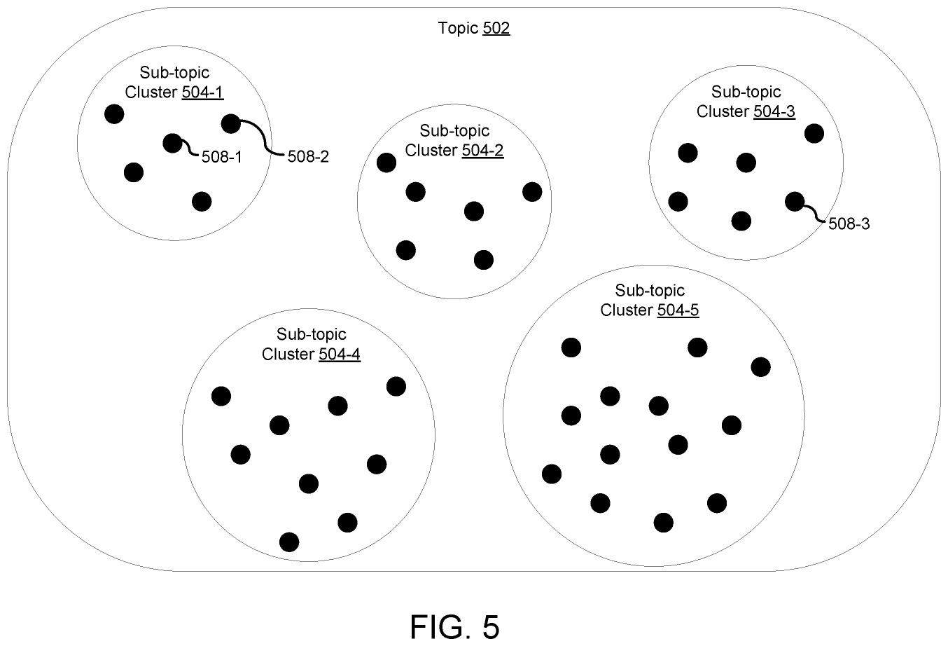

FIG. 5 illustrates a topic space 502 with sub-topic clusters 504 in accordance with some embodiments. As shown in FIG. 5, the topic space 502 includes multiple sub-topic clusters 504 (e.g., sub-topic clusters 504-1, 504-2, 504-3, 504-4, and 504-5). For example, the topic may be ‘Natural Resources’ and the sub-topics may include ‘Minerals’, ‘Forests’, ‘Water’, and ‘Land’. Each sub-topic cluster 504 includes media items 508. For example, the sub-topic cluster 504-1 includes media items 508-1 and 508-2 and the sub-topic cluster 504-3 includes a media item 508-3. The media item 508-1 is an example of a media item closest to a centroid of the sub-topic cluster 504-1. In some embodiments, the topic space 502 includes one or more media items not in a sub-topic cluster, e.g., which can be considered as outliers that lack semantic closeness to any other sub-topic cluster. In some embodiments, the outliers are discarded (e.g., not included in a results subset).

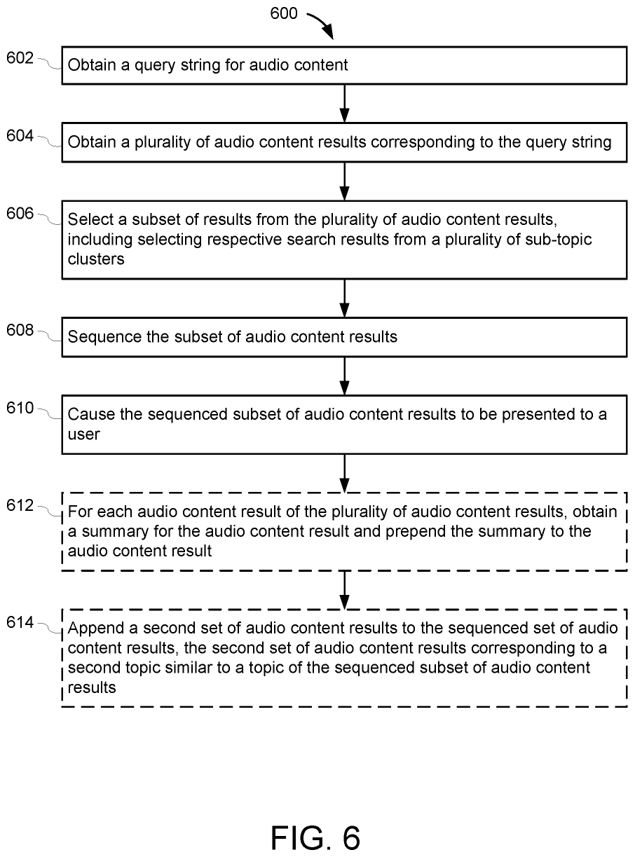

FIG. 6 is a flow diagram illustrating a method 600 of recommending content to a user in accordance with some embodiments. The method 600 may be performed at a computing system (e.g., media content server 104 and/or electronic device(s) 102) having one or more processors and memory storing instructions for execution by the one or more processors. In some embodiments, the method 600 is performed by executing instructions stored in the memory (e.g., memory 212, FIG. 2 and/or memory 306, FIG. 3) of the computing system. In some embodiments, the method 600 is performed by a combination of the server system (e.g., including media content server 104 and CDN 106) and a client device.

The system obtains (602) a query string (e.g., the query 401) for audio content. For example, the system obtains a query string from a consumer (e.g., a listener). In some embodiments, the query string corresponds to a topic. In some embodiments, the query string corresponds to a request for a playlist relating to the topic.

The system obtains (604) a plurality of audio content results (e.g., the result sets 404) corresponding to the query string. In some embodiments, the system obtains the plurality of audio content results using one or more indices (e.g., the indices 402). In some embodiments, obtaining the plurality of audio content results includes obtaining a set of top-N nearest neighbors to the query string.

The system selects (606) a subset of results (e.g., the result subsets 406) from the plurality of audio content results, including selecting respective search results from a plurality of sub-topic clusters (e.g., the sub-topic clusters 504). In some embodiments, selecting the subset of results includes filtering out similar audio content results (e.g., using the filter module 326). In some embodiments, selecting a subset of results from the plurality of audio content results includes filtering the audio content results based on recency and/or duration. In some embodiments, the system clusters the plurality of audio content results into the plurality of sub-topic clusters (e.g., before or after the filtering), where the plurality of sub-topic clusters are generated using a topic model.

The system sequences (608) the subset of audio content results (e.g., generates the sequenced set 408-1). In some embodiments, sequencing the subset of audio content results includes ordering the audio content results based on level of detail and/or specificity. In some embodiments, sequencing the subset of audio content results includes ordering the audio content results based on chronology, sentiment, and/or textual entailment. In some embodiments, sequencing the subset of audio content results includes selecting a sequencing methodology based on an identified topic for the query string.

The system causes (610) the sequenced subset of audio content results to be presented to a user. In some embodiments, the sequenced subset of audio content results are presented to the user as a playlist. In some embodiments, the sequenced subset of audio content results are transmitted to an electronic device 102 and the electronic device 102 presents the sequenced subset of audio content results to a user (e.g., a consumer).

In some embodiments, for each audio content result of the plurality of audio content results, the system obtains (612) a summary for the audio content result and prepends the summary to the audio content result. For example, the system generates the summary using a summarization model (e.g., a transformer model and/or a generative model). In some embodiments, the system uses a text-to-speech model to read out the summary to a listener.

In some embodiments, the system appends (614) a second set of audio content results (e.g., the sequenced set 408-2) to the sequenced set of audio content results, the second set of audio content results corresponding to a second topic similar to a topic of the sequenced subset of audio content results. In some embodiments, the system is configured to repeat the appending operation (e.g., appending a third, fourth, etc. set of audio content results) as a listener completes a previous set of audio content results (e.g., to provide an ‘endless’ listening experience across multiple related topics).

Although FIG. 6 illustrates a number of logical stages in a particular order, stages which are not order dependent may be reordered and other stages may be combined or broken out. Some reordering or other groupings not specifically mentioned will be apparent to those of ordinary skill in the art, so the ordering and groupings presented herein are not exhaustive. Moreover, it should be recognized that the stages could be implemented in hardware, firmware, software, or any combination thereof.

Turning now to some example embodiments.

(A1) In one aspect, some embodiments include a method (e.g., the method 600) of searching audio content. The method includes: (i) obtaining a query string (e.g., the query 401) for audio content (e.g., receiving a query from an electronic device 102); (ii) obtaining a plurality of audio content results (e.g., the result sets 404) corresponding to the query string (e.g., using the search module 227); (iii) selecting a subset of results (e.g., the result subsets 406) from the plurality of audio content results (e.g., using the filter module 326), including selecting respective search results from a plurality of sub-topic clusters (e.g., the sub-topic clusters 504); (iv) sequencing (e.g., via the playlist module 318) the subset of audio content results (e.g., generating the sequenced set 408-1); and (v) causing the sequenced subset of audio content results to be presented to a user (e.g., presented via the user interface 204). In some embodiments, the query string identifies a topic and/or theme. In some embodiments, the query string is prepended to the sequenced subset of audio content results (e.g., to be read out to the user via a text-to-speech model).

(A2) In some embodiments of A1, the plurality of audio content results are obtained by generating a topic embedding from the query string and comparing the topic embedding to a topic index for media content (e.g., comparing the topic embedding to a content index 334). In some embodiments, a method of generating a topic index includes (i) obtaining audio content; (ii) extracting vocabulary terms from the audio content; (iii) generating, using a transformer model, a vocabulary embedding from the vocabulary terms; (iv) generating one or more topic embeddings from the audio content and the vocabulary embeddings; (v) generating a topic embedding index for the audio content based on the one or more topic embeddings; and (vi) storing the embedding index for use with a search engine system. Additional details regarding topic embedding indices can be found in the U.S. patent application Ser. No. 18/063,023, which is incorporated by reference in its entirety. In some embodiments, the plurality of audio content results are obtained based on extracted keywords from the audio content items (e.g., textual matching). In some embodiments, the plurality of audio content results are obtained based on semantic embeddings (e.g., XLM embeddings). In some embodiments, the plurality of audio content results are obtained using one or more indices (e.g., an episode index and/or a segment index). In some embodiments, the plurality of audio content results are obtained using cosine similarity, dot product, and/or Euclidean distance.

(A3) In some embodiments of A1 or A2, selecting the subset of results includes filtering out similar audio content results (e.g., via the filter module 326). For example, the filtering includes filtering out content having a same viewpoint and/or talking points. In some embodiments, the results are filtered to increase (maximize) narrative diversity. In some embodiments, the filtering includes identifying a set of similar audio content results and selecting only a representative result from the set of similar audio content results.

(A4) In some embodiments of any of A1-A3, selecting a subset of results from the plurality of audio content results includes filtering out undesired audio content results based on one or more user preferences (e.g., based on preferences relating to language, file format, locality, and/or explicitness). In some embodiments, selecting the subset of results includes maximizing narrative diversity (e.g., providing diverse perspectives on an identified topic).

(A5) In some embodiments of any of A1-A4, selecting the subset of results includes filtering out audio content results corresponding to the same episode (e.g., selecting only a highest scored segment from a particular episode). In some embodiments, the segments are scored based on length and semantic similarity to the query.

(A6) In some embodiments of any of A1-A5, selecting a subset of results from the plurality of audio content results includes filtering out audio content results based on one or more machine-generated labels (e.g., filtering out non-speech audio and/or audio with a language different from the user). In some embodiments, the filtering includes filtering out audio content results based on metadata (e.g., indicating a media category, host name, and/or named entities involved in the audio content).

(A7) In some embodiments of any of A1-A6, selecting a subset of results from the plurality of audio content results includes filtering the audio content results based on recency and/or duration (e.g., filtering out content items that are too old, too short, and/or too long). In some embodiments, the audio content results are filtered based on starting point (e.g., a segment starting point within an episode).

(A8) In some embodiments of any of A1-A7, the method further includes clustering the plurality of audio content results into the plurality of sub-topic clusters (e.g., the sub-topic clusters 504). In some embodiments, the clustering is unsupervised clustering (e.g., using k-means). In some embodiments, a desired number of clusters for the clustering is preset. In some embodiments, a desired number of media items for each result subset 406 and/or the sequenced set 408-1 is preset. In some embodiments, the clustering is nonparametric clustering (e.g., the number of clusters is automatically discovered based on differences in the data pool).

(A9) In some embodiments of A8, the plurality of sub-topic clusters are generated using a topic model (e.g., a latent Dirichlet allocation (LDA) model). In some embodiments, the sub-topic clusters are generated using a weighted vocabulary (e.g., via a TF-IDF process).

(A10) In some embodiments of any of A1-A9, selecting respective search results from the plurality of sub-topic clusters includes selecting one search result from each sub-topic cluster of the plurality of sub-topic clusters. For example, selecting one search result from each of the sub-topic clusters 504. In some embodiments, one search result is selected from each sub-topic cluster of at least a subset of the plurality of sub-topic clusters. For example, in a case where 100 sub-topic clusters are identified and a preset number of items for a result subset is 20, a single item may be selected from each of 20 different sub-topic clusters (with no items selected for the other 80 sub-topic clusters).

(A11) In some embodiments of any of A1-A10, selecting the respective search results from the plurality of sub-topic clusters includes selecting a respective search result nearest to a centroid of each sub-topic cluster. For example, selecting the media item 508-1 in the sub-topic cluster 504-1.

(A12) In some embodiments of any of A1-A11, sequencing the subset of audio content results includes ordering the audio content results based on level of detail and/or specificity (e.g., broader segments first and more detailed segments after). In some embodiments, the system uses TF-IDF to determine the level of detail and/or specificity.

(A13) In some embodiments of any of A1-A12, sequencing the subset of audio content results includes ordering the audio content results based on chronology, sentiment, and/or textual entailment. For example, the audio content results can be ordered so that older content items are before newer content items. In some embodiments, the audio content results are ordered based on respective timestamps for the audio content results (e.g., a publish date or generation date).

(A14) In some embodiments of A13, ordering the audio content results based on sentiment includes sequencing the audio content so as to have a sentiment shift between content items that is within a predetermined range. For example, sequencing the audio content so that sentiment changes slowly/progressively as the set progresses, rather than changing abruptly between content items. In some embodiments, the audio content is sequenced to have at least a minimum amount of sentiment change between content items (e.g., to maximize sentiment changes). In some embodiments, the ordering of the audio content results includes ordering based on sentiment-based narrative progression (e.g., alternating clusters of positive sentiment and negative sentiment segments).

(A15) In some embodiments of A13 or A14, ordering the audio content results based on textual entailment includes determining that a literary continuity between content items meets one or more preset criteria. In some embodiments, ordering the audio content results based on textual entailment includes determining a pairwise entailment relationship for each pair of audio content results. Pairwise relationships imply an n-by-n symmetric matrix between n content items and themselves, where the scores can be computed automatically, e.g., using a two-sequence transformer model fine-tuned on entailment. An example model predicts an entailment score between segment i and segment j via inputting the end of segment i and the start of segment j into the model. A greedy algorithm can be applied to the matrix of scores to acquire the sequencing (e.g., for each possible starting segment, find its corresponding best path greedily, then compare all such possible paths and finally pick the path that has the overall highest score globally). For example, a starting segment i is selected, then the highest value for row i in the matrix is identified (corresponding to segment j), and segment j is selected as the next segment. The example process continues with identifying row j in the matrix and selecting the highest entry again.

(A16) In some embodiments of any of A1-A15, sequencing the subset of audio content results includes selecting a sequencing methodology based on an identified topic for the query string. For example, sequencing for a first topic may be chronological, while sequencing for a second topic may be based on textual entailment.

(A17) In some embodiments of any of A1-A16, the audio content results include one or more of: podcasts, podcast segments, audio books, audio book segments, talk shows, talk show segments, episodes, and episode segments.

(A18) In some embodiments of any of A1-A17, the query string is obtained from a user via a search interface. For example, the user enters the query string at an electronic device 102 and the query string is transmitted to the media content server 104.

(A19) In some embodiments of any of A1-A18, the query string is generated for a particular theme or event (e.g., generated by an administrator). For example, a content creator and/or distributor may submit the query string to generate a sequenced set for a particular theme or event.

(A20) In some embodiments of any of A1-A19, obtaining the plurality of audio content results comprises obtaining a set of top-N nearest neighbors (e.g., using a k-nearest neighbors (KNN) algorithm) to the query string.

(A21) In some embodiments of any of A1-A20, the sequenced subset of audio content results are presented to the user as a playlist (e.g., via the playlist module 224 and/or the user interface 204).

(A22) In some embodiments of any of A1-A21, the method further includes, for each audio content result of the plurality of audio content results: (i) obtaining a summary for the audio content result; and (ii) prepending the summary to the audio content result (e.g., a TTS summary). For example, a generative model may be used to create a context ‘header’ or contextual transition, thereby providing a big picture explanation or a personalized explanation, which can be provided in pure-text or as TTS for audio modality. As an example, a sequenced set may include a respective TTS summary that is played back before a corresponding content item (e.g., to introduce the corresponding content item). In some embodiments, the method further includes generating a title for the sequenced set (e.g., using an extreme summarization (XSum) process). In some embodiments, the system determines whether a creator-provided summary is provided for a content item, selects the creator-provided summary if it is provided, and generates a summary if a creator-provided summary is not provided.

(A23) In some embodiments of any of A1-A22, the method further includes appending a second set of audio content results to the sequenced set of audio content results, the second set of audio content results corresponding to a second topic similar to a topic of the sequenced subset of audio content results. In some embodiments, the method includes appending a sequenced set after each previous sequenced set is played back (e.g., creating an ‘endless’ listening experience). In some embodiments, a second sequenced set of audio content results is provided to a listener based on a topic similarity with the audio content item in the sequenced set of audio content results that was most recently played back by the listener.

(A24) In some embodiments of A23, the second topic is determined to be similar based on a knowledge graph of topics.

(A25) In some embodiments of A23 or A24, the second topic is determined to be similar based on a topic embedding space.

In another aspect, some embodiments include a computing system including one or more processors and memory coupled to the one or more processors, the memory storing one or more programs configured to be executed by the one or more processors, the one or more programs including instructions for performing any of the methods described herein (e.g., the methods 600 and A1-A25 above).

In yet another aspect, some embodiments include a non-transitory computer-readable storage medium storing one or more programs for execution by one or more processors of a computing system, the one or more programs including instructions for performing any of the methods described herein (e.g., the methods 600 and A1-A25 above).

It will also be understood that, although the terms first, second, etc. are, in some instances, used herein to describe various elements, these elements should not be limited by these terms. These terms are used only to distinguish one element from another. For example, a first electronic device could be termed a second electronic device, and, similarly, a second electronic device could be termed a first electronic device, without departing from the scope of the various described embodiments. The first electronic device and the second electronic device are both electronic devices, but they are not the same electronic device.

The terminology used in the description of the various embodiments described herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

The foregoing description, for purpose of explanation, has been described with reference to specific embodiments. However, the illustrative discussions above are not intended to be exhaustive or to limit the embodiments to the precise forms disclosed. Many modifications and variations are possible in view of the above teachings. The embodiments were chosen and described in order to best explain the principles and their practical applications, to thereby enable others skilled in the art to best utilize the embodiments and various embodiments with various modifications as are suited to the particular use contemplated.

1. A method for sequencing audio content for playback, comprising:
obtaining a query string for audio content;
obtaining a plurality of audio content results corresponding to a topic of the query string;
clustering the plurality of audio content results into a plurality of sub-topic clusters that correspond to the topic, the clustering being based on one or more representations of speech respectively associated with the plurality of audio content results;
selecting a subset of results from the plurality of audio content results, including selecting respective search results from the plurality of sub-topic clusters that correspond to the topic;
sequencing the subset of audio content results; and
causing the sequenced subset of audio content results to be presented at a media device to a user for playback on the media device.

2. The method of claim 1, wherein selecting the subset of results includes filtering out similar audio content results.

3. The method of claim 1, wherein selecting the subset of results from the plurality of audio content results includes filtering the audio content results based on recency and/or duration.

4. The method of claim 1, wherein the plurality of sub-topic clusters are generated using a topic model.

5. The method of claim 1, wherein selecting respective search results from the plurality of sub-topic clusters comprises selecting one search result from each sub-topic cluster of the plurality of sub-topic clusters.

6. The method of claim 1, wherein selecting the respective search results from the plurality of sub-topic clusters comprises selecting a respective search result nearest to a centroid of each sub-topic cluster.

7. The method of claim 1, wherein sequencing the subset of audio content results includes ordering the audio content results based on level of detail.

8. The method of claim 1, wherein sequencing the subset of audio content results includes ordering the audio content results based on chronology, sentiment, and/or textual entailment.

9. The method of claim 1, wherein sequencing the subset of audio content results includes selecting a sequencing methodology based on an identified topic for the query string.

10. The method of claim 1, wherein obtaining the plurality of audio content results comprises obtaining a set of top-N nearest neighbors to the query string.

11. (canceled)

12. The method of claim 1, further comprising, for each audio content result of the plurality of audio content results:
obtaining a summary for the audio content result; and
prepending the summary to the audio content result.

13. The method of claim 1, further comprising appending a second set of audio content results to the sequenced subset of audio content results, the second set of audio content results corresponding to a second topic similar to the topic of the sequenced subset of audio content results.

14. A computing system, comprising:
one or more processors;
memory; and
one or more programs stored in the memory and configured for execution by the one or more processors, the one or more programs comprising instructions for:
obtaining a query string for audio content;
obtaining a plurality of audio content results corresponding to a topic of the query string;
clustering the plurality of audio content results into a plurality of sub-topic clusters that correspond to the topic, the clustering being based on one or more representations of speech respectively associated with the plurality of audio content results;
selecting a subset of results from the plurality of audio content results, including selecting respective search results from the plurality of sub-topic clusters that correspond to the topic;
sequencing the subset of audio content results; and
causing the sequenced subset of audio content results to be presented at a media device to a user for playback on the media device.

15. The computing system of claim 14, wherein selecting the subset of results includes filtering out similar audio content results.

16. The computing system of claim 14, wherein selecting the subset of results from the plurality of audio content results includes filtering the audio content results based on recency and/or duration.

17. The computing system of claim 14, wherein selecting respective search results from the plurality of sub-topic clusters comprises selecting one search result from each sub-topic cluster of the plurality of sub-topic clusters.

18. A non-transitory computer-readable storage medium storing one or more programs configured for execution by a computing device having one or more processors and memory, the one or more programs comprising instructions for:
obtaining a query string for audio content;
obtaining a plurality of audio content results corresponding to a topic of the query string;
clustering the plurality of audio content results into a plurality of sub-topic clusters that correspond to the topic, the clustering being based on one or more representations of speech respectively associated with the plurality of audio content results;
selecting a subset of results from the plurality of audio content results, including selecting respective search results from the plurality of sub-topic clusters that correspond to the topic;
sequencing the subset of audio content results; and
causing the sequenced subset of audio content results to be presented at a media device to a user for playback on the media device.

19. (canceled)

20. The non-transitory computer-readable storage medium of claim 18, wherein selecting the subset of results from the plurality of audio content results includes filtering the audio content results based on recency and/or duration.

21. The method of claim 1, wherein each audio content result of the subset of the audio content results is associated with a respective sentiment value.

22. The method of claim 21, wherein sequencing the subset of audio content results further comprises:
arranging the audio content results based on slowly progressing sentiment values or alternating positive and negative sentiment values.
